(19) United States
(12) Patent Application Publication
(10) Pub. No.: US 2012/0174379 A1
(43) Pub. Date: Jul. 12, 2012

(54) METHOD AND APPARATUS FOR APPLYING PRESET TORQUE VALUES TO FASTENERS

(76) Inventor: Boris R. Teper, Farmington Hills, MI (US)

(21) Appl. No.: 13/423,630

(22) Filed: Mar. 19, 2012

Related U.S. Application Data
(63) Continuation-in-part of application No. 12/831,750, filed on Jul. 7, 2010.
(60) Provisional application No. 61/266,221, filed on Dec. 3, 2009.

(51) Int. Cl. B25B 23/143; B23P 11/00

(52) U.S. Cl. 29/434; 81/480

(57) ABSTRACT

A torque driver has a driver arm with a first end and an opposite second end, a driver spindle attached at the first end of the driver arm, and a tangential force limiter attached at the second end of the driver arm and including a tangential force applicator for applying a force to rotate the driver spindle about an axis of rotation. The force applicator is movable in a direction tangential to a path of rotation of the force limiter about the axis of rotation in response to the application of a predetermined force to indicate that an associated predetermined tightening torque value has been applied to a fastener engaged by the driver spindle

### CROSS-REFERENCE TO RELATED APPLICATION

This application is a continuation-in-part of the co-pending U.S. patent application Ser. No. 12/831,750 filed Jul. 7, 2010 claiming the benefit of U.S. provisional patent application Ser. No. 61/266,221 filed Dec. 3, 2009.

### BACKGROUND OF THE INVENTION

The present invention relates generally to an apparatus and a method for tightening fasteners with torque limiting.

In the course of many mechanical assembly operations, it is important to tighten a fastener with a specified torque, so that the optimal potential of the fastener is utilized and/or overload of parts fastened together is prevented in order to avoid the danger of damage to either the parts or the fastener itself. One example of such operation, where the correct tightening of the fasteners is of great importance, is the mounting of optical scopes into scope rings. It is common knowledge that the scope ring fasteners should be tightened to strictly controlled values. Exceeding these values may cause damage to the thin wall scope bodies, while a smaller than required tightening torque applied to the fasteners may result in insufficient clamping force, which, in turn, may cause movement of the scope under force of the firearm recoil, with the loss of the preset scope setting as the direct result of such scope movement relative to the rings.

It has been known to use special torque-limiting or torque setting devices, such as adjustable or preset torque drivers of different configurations. While adjustable torque drivers allow the user to set up such devices to desired tightening torque values using a mechanically based scale normally incorporated into such device, these devices suffer from certain inconsistency and relatively low repeatability of the same settings, as the human eye is often not capable of precisely identifying the same spot on the relatively low resolution scale typical of such mechanical devices. In addition, the vast majority of such devices are based on the use of “cam-over” and “slip clutch” systems and precision springs, which must be manufactured with a high degree of accuracy to assist in maintaining precision and consistency of the torque driver. As a consequence of having precision parts, such devices may be expensive and may also require labor intensive calibration. An example of such device is shown in U.S. Pat. No. 7,383,756. While an adjustable torque driver can be made with a digital readout, which improves resolution of the scale, and may utilize a load cell as a torque registering element instead of the mechanically based click-clutch system, the cost of such a digital adjustable torque driver is relatively high, which limits its use.

Preset torque drivers, for example the one shown in U.S. Pat. No. 6,662,693, typically have a much simpler construction and lower cost, but are only able to deliver a single fixed torque setting, although, despite more simple construction, with a higher degree of precision and consistency in comparison with the adjustable torque driver. This driver design is typically not intended to be re-adjusted by the user, and therefore, can only deliver a single factory preset torque limiting value.

The single setting limitation is also considered to be a certain weakness by the users, who may often need to use more than one preset torque driver to cover the need for several fastening applications requiring at least several fixed torque settings, in which case the cost to the user to own these tools becomes considerable.

Another known preset “break-over” torque driver design, for example the one shown in Mountz, Inc. Catalog section 3.6-3.9, or described by U.S. Pat. No. 6,138,539, possesses relatively high accuracy potential and capability to be used in difficult to reach places, along with availability of certain adjustments by the user, which can be accomplished thru adjustment of the internal compression type spring. However, in order to guarantee the accuracy of adjustment, this type of preset torque driver, which has no adjustment scale, must be set up with the additional use of a torque analyzer. In addition, even with this capability to be set up to the new torque limiting value, this design can still deliver only one torque setting between adjustments, and the need to use a torque analyzer makes practical implementation of this driver very expensive for the user. While the manufacturer offers a selection of preset driver handles, which can be switched to obtain different torque limiting settings without the use of a torque analyzer, the cost of the base “break-over” type torque driver combined with the need to have several optional handles remains quite high for the user. It is important to mention that the implementation of a pivotable “break-over” handle depends upon the practical ability of the user to apply the tightening force in a tangential direction to the specific, distance related spot on the pivotable handle, and if such ability happens to be limited, the tightening torque accuracy potential of such “break-over” design may not be fully realized.

U.S. Utility patent application Ser. No. 12/831,750 describes a “break-over” multi torque driver with the capability to deliver numerous preset torque settings in a simple and cost effective design. Still, the practical limitation of ability for some users to apply a tightening force in a tangential direction to the certain spot of the pivotable handle in order to achieve high accuracy of tightening torque may cause certain deviation in tightening torque accuracy. In addition, the ergonomics of the pivotable handle may not be always suitable for all the users, for example, for users with extremely large or small hands.

Therefore, it would be beneficial to propose a torque tightening method and an improved configuration of the multi torque driver capable of delivering highly accurate, consistent and repeatable preset torque settings for tightening the fasteners while being considerably less dependent upon individual user abilities to achieve this objective. It would be also very beneficial if such a torque driver design would allow even wider tightening torque value selection capability, but in combination with a simple, easy to manufacture and low cost design.

### SUMMARY OF THE INVENTION

The present invention concerns a torque driver which incorporates a driver arm with attached spindle for mounting various means for fastener engagement and a tangential force limiter with at least one, but typically, with several tangential force limiting settings, selectable by the user, and mounted into the arm at specified distance from the center of spindle rotation.

The same torque driver may also have a built-in capability for easy replacement of the tangential force limiter, allowing the user to quickly remove the force limiter and replace it with either the same one, if required for purposes of maintenance or repair, or with the same principle design force limiter having different tangential force limit(s), better suited for the user application. Such implementation of replaceable tangential torque limiters provides alternative tangential force limit values, and, correspondingly, torque limiting values, and represents a simple and practical way to expand the range of available tightening torque values.

The same torque driver may also incorporate means for adjustment, by the user, of the distance between the tangential torque limiter and the center of spindle rotation, in order to obtain additional tightening torque values. This can be accomplished by making the slidable driver arm with a tangential force limiter mounted thereon and being lockable relative to the driver spindle, and using an appropriately marked scale. Said adjustment of the effective driver arm length can be made continuous (stepless) or in any number of steps, tailored to specific application.

The same torque driver may also incorporate a double sided tangential torque limiter, capable of providing two limit forces, with only one of them being active in the direction of tightening the fasteners. This makes it possible to double the range of adjustment simply by removal and re-installation of the driver arm by the user, so that the torque limiter changes to the opposite orientation and makes the other limit force available for tightening the fasteners.

In the same torque driver, the combination of adjustment for the driver arm length and availability for easy replacement of tangential force limiters creates the potential for expanding the range of adjustability both by the user selectable tangential force limits and the variable user set distance between the driver spindle and the effective driver arm length.

A method of providing the multiple tightening torque values in a driver with a preset and user selectable tangential force limiters, mounted to the driver arm, is based on the potential of the proposed torque driver to generate multiple tightening torque values. The range of these values can be further expanded by having the driver arm of adjustable length, which changes the distance between the location of the tangential force application, and the driver spindle. Therefore, the tightening torque, or moment of force applied to the fastener, is determined by the preset release force in the tangential direction, provided by the tangential force limiter, and the distance between the applied tangential force and the driver spindle. This distance is either fixed or can be adjusted by sliding and then locking the driver arm relative to the driver spindle.

Operation of the proposed torque driver is based on the principle of applying a specified tangential force to the slidable, in a tangential direction, force applicator, initially restricted from movement relative the driver arm by the locking element incorporated into the tangential force limiter, which is mounted to the driver arm. Upon reaching a specified tangential force, which corresponds to specified torque value, a locking element of the said limiter disengages from a corresponding locking detent of the force applicator, which, in turn, causes the force applicator to slide in the tangential direction relative to the driver arm. The distance of this slidable movement is chosen to be sufficient to provide a clear indication to the user that the specified tangential force was reached, and, as the result, the desired tightening torque value was fully applied to the fastener. This movement from the force applicator, combined with an audible sound of the locking element disengagement with the force applicator, instructs the user that no more application of tangential force is required, and therefore, results in effective cancellation of the torque action of the driver, thus preventing further fastener tightening.

The torque driver apparatus according to the invention comprises: a driver arm having a driver spindle and means for mounting of a tangential force limiter to the driver arm, said mounting means spaced from said driver spindle, and a tangential force limiter, configured as a separate sub-assembly and having means to engage said mounting means of the driver arm to form a complete torque driver assembly.

The torque driver according to the invention comprises: a driver arm having a first end and an opposite second end; a driver spindle attached at said first end of said driver arm; and a tangential force limiter attached at said second end of said driver arm and including a tangential force applicator for applying a force to rotate said driver spindle about an axis of rotation, said force applicator being movable in a direction tangential to a path of rotation of the force limiter about the axis of rotation in response to the application of a predetermined force to indicate that an associated predetermined tightening torque value has been applied to a fastener engaged by said driver spindle.

The torque driver according to the invention comprises: a driver arm having a first end and a second end; a driver spindle attached to said first end of said driver arm and having an axis of rotation; a tangential force limiter attached at said second end of said driver arm and having a tangential force applicator for applying a force to rotate said driver arm and said driver spindle about the axis of rotation to apply a torque to an object engaged by said spindle driver, a locking element and a load applicator; and wherein said force applicator has an elongated body with a locking detent formed therein, said load applicator presses said locking element into engagement with said locking detent, and said elongated body is movable in a direction tangential to a path of rotation of the force limiter about the axis of rotation in response to application of a predetermined force to indicate that an associated predetermined tightening torque value has been applied to the object.

A method of limited torque fastener tightening according to the invention comprises the steps of: providing a driver spindle; connecting the driver spindle to a driver arm; providing a tangential force limiter including a tangential force applicator; connecting the force limiter to the driver arm; selecting a predetermined tightening torque by either adjusting a distance between the force applicator and an axis of rotation of the driver spindle, or by adjusting a value of an actuating force of the force limiter, or both of them at the same time; engaging the driver spindle with an object to be rotated; and applying a tightening force to the force applicator to rotate the arm and the driver spindle whereby the force applicator moves relative to the driver arm to prevent further application of the tightening torque to the object upon being exposed to adjusted value of the tightening force.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is an exploded perspective view of an adjustable combination torque driver in accordance with the first embodiment of the invention described in the U.S. patent application Ser. No. 12/831,750;

FIG. 2 is a top plan view an adjustable combination torque driver in accordance with a second embodiment of the invention;

FIG. 3 is an exploded perspective view of the torque driver shown in FIG. 2 with the tangential force limiter separated from the driver arm;

FIG. 4 is a an exploded perspective view of the tangential force limiter shown in FIG. 3;

FIG. 5 is a perspective view of the torque driver shown in FIG. 3 with the tangential force limiter actuated;

FIG. 6 is a perspective view of an adjustable combination torque driver in accordance with a third embodiment of the invention;

FIG. 7 is a view similar to FIG. 6 with the latch released;

FIG. 8 is a perspective view of an adjustable combination torque driver in accordance with a fourth embodiment of the invention;

FIG. 9 is an exploded perspective view of the torque driver shown in FIG. 8;

FIG. 10 is an exploded perspective view of the driver arm and tangential force limiter shown in FIG. 9;

FIGS. 11a and 11b are perspective views from opposite sides of the assembled driver arm and force limiter shown in FIG. 9;

FIG. 12 is an exploded perspective view of the tangential force limiter shown in FIG. 10;

FIG. 13 is a perspective view of an adjustable combination torque driver in accordance with a fifth embodiment of the invention;

FIGS. 14a and 14b are perspective views from opposite sides of the driver arm shown in FIG. 13;

FIG. 15 is a perspective view of the clam shown in FIG. 13;

FIG. 16 is a perspective view of an adjustable torque driver in accordance with a sixth embodiment of the invention;

FIG. 17 is a cross-sectional view taken along the line A-A in FIG. 16; and

FIG. 18 is a perspective view of the tangential force applicator shown in FIG. 16,

### DESCRIPTION OF THE PREFERRED EMBODIMENTS

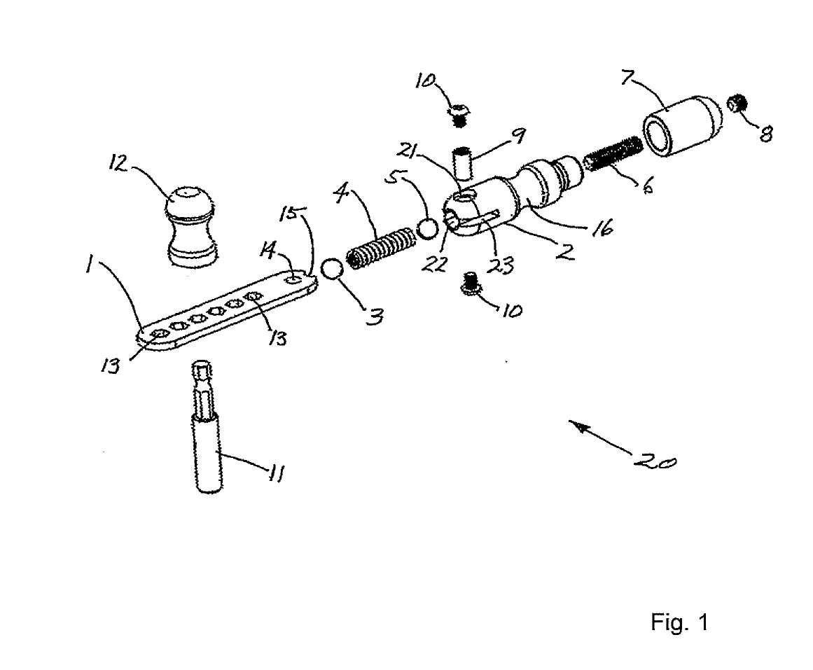

U.S. patent application Ser. No. 12/831,750, filed Jul. 7, 2010, is incorporated herein by reference. The torque driver 20 shown therein (FIG. 1) includes a driver arm 1 with at least two driver spindle sockets 13 (an arm with a total of six sockets is shown), positioned at specified distances from an arm pivot mounting hole 14, and a locking detent 15 of either symmetrical (shown) or asymmetrical configuration (not shown), positioned at a specified distance from the arm pivot mounting hole 14. An arm handle 2 has a tightening force application spot 16 positioned at a specified distance from a handle pivot mounting hole 21, and means of accommodating related elements of an arm-to-handle locking system and locking system adjustment. A locking element 3 is shaped as a ball as shown. A locking element load applicator 4 is formed as a coiled compression spring. A load transfer element 5 is shaped as a ball. A load adjustment element 6 is formed as a screw.

Other elements of the torque driver 20 are a load adjustment element knob 7, a load adjustment knob position lock element 8 formed as a screw, a cylindrical pivot element 9 internally threaded at both ends, a pair of pivot retainers 10 formed as screws, a driver spindle 11, and a driver spindle retaining knob 12. The arm handle 2 has the hole 21 formed as a through aperture that extends traverse to a longitudinally extending bore 22 in the handle. The bore 22 has a larger diameter portion that retains the spring 4 between the ball 3 and the ball 5. The ball 5 is positioned adjacent an inner end of the larger diameter portion and the ball 3 is exposed at an opposite open end of the portion. The bore 22 has a smaller diameter portion that threadably retains a screw used to set the value of the load applied by the spring 4.

The arm handle 2 also has a slot 23 formed therein extending in a plane transverse to the longitudinal axis of the aperture 21 and centered on the longitudinally extending bore 22. The end of the arm 1 having the detent 15 is inserted in the slot 23 with the mounting hole 14 aligned with the aperture 21. The pivot element 9 is inserted into the aperture 21 and the mounting hole 14 and is retained by the retainers 10. Thus, the arm 1 can pivot on the pivot element 9 in the plane of the slot 23.

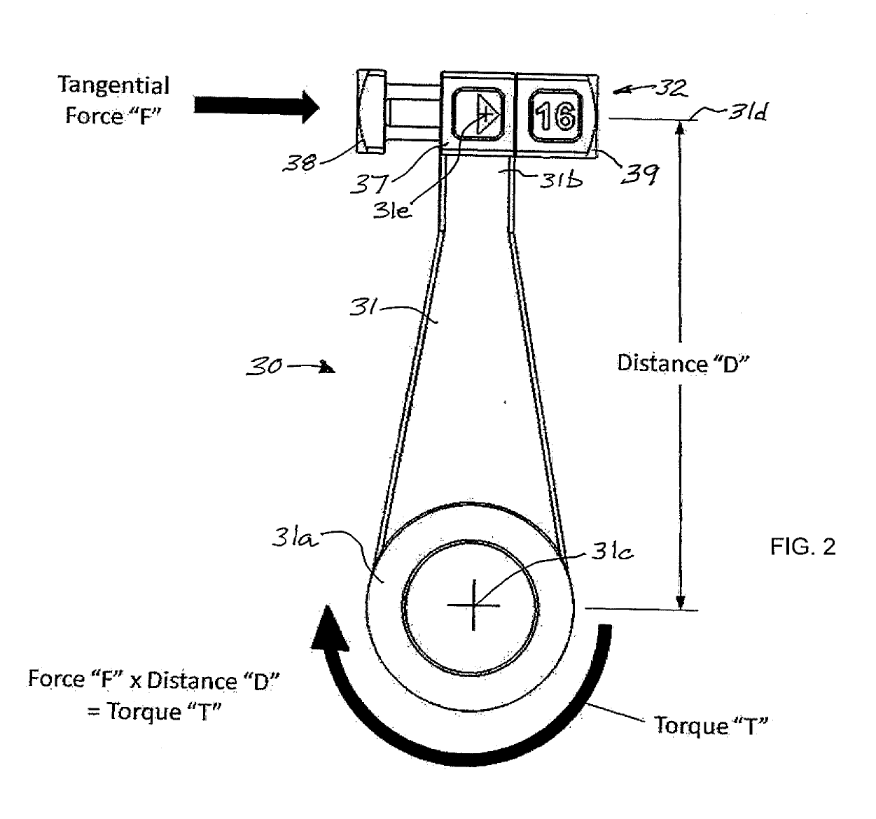

The present invention concerns another embodiment torque driver 30 (FIGS. 2-5) that includes a driver arm 31 with a first end 31a for mounting a driver spindle (not shown) and an opposite second end 31 b for mounting a tangential force limiter 32. The first end 31a includes an axis of rotation 31c for the driver spindle. The second end 31b of the arm 31 includes the tangential force limiter 32 mounted thereon. A moment of force (torque “T”) that is applied to a fastener by the torque driver 30 is a function of the tangential force “F” applied at the tangential force limiter 32 multiplied by a distance “D” between the axis 31c and a centerline 31d of the limiter 32 intersecting a longitudinal axis of the arm 31 at a point 31e.

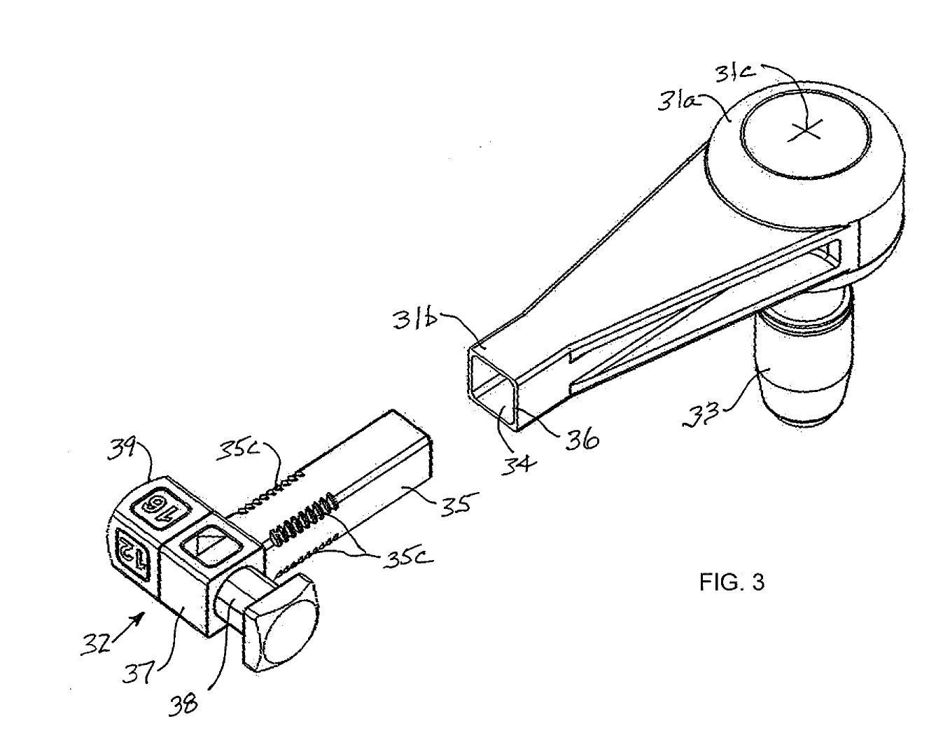

As shown in FIG. 3, a driver spindle 33 is mounted at the end 31a of the driver arm 31. The driver arm 31 has an aperture 34 formed in the second end 31b for accepting therein a leg 35 of the tangential force limiter 32. The driver arm second end 31b and the leg 35 are depicted with a square cross-section, but could have any suitable shape. The leg 35 is inserted into the aperture 34 until a wall portion 36 of the driver arm 31 surrounding the aperture 34 abuts a surface of a body 37 of from which the leg extends. Thus, a pre-determined distance between the tangential force applicator 38 and the rotation axis 31c for the driver spindle 33 is set during the final assembly of the torque driver 30.

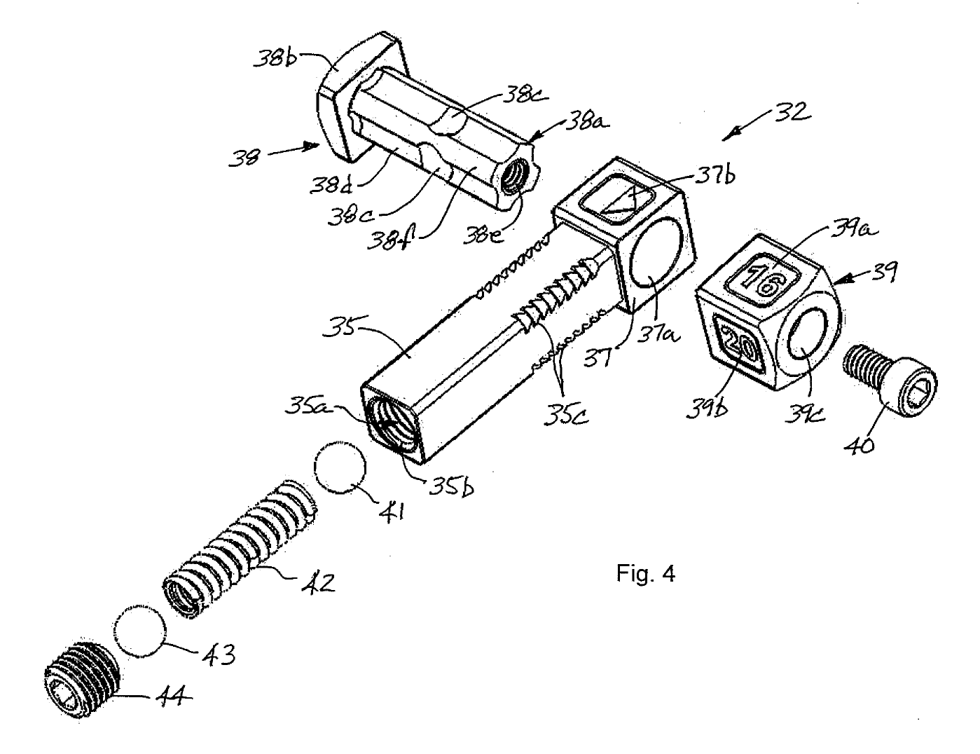

The tangential force limiter 32 is executed as a sub-assembly (FIG. 4) and includes the body 37, a tangential force applicator 38, a tightening torque values selector knob 39 and a selector knob retaining screw 40. The tangential force applicator 38 has an elongated body 38a with a force applicator button 38b positioned at one end. A plurality of evenly spaced symmetrical curved locking detents 38c are located approximately midway between the ends of the body 38a. Four of the locking detents 38c are provided as an example, but more or less could be utilized. Each of the locking detents 38c is located in an associated longitudinally extending groove 38d formed on the exterior of the body 38a and has a different depth curved shape. A threaded hole 38e is formed in the end of the body 38a opposite the button 38b. The hole 38e threadably receives the retaining screw 40. Each of the locking detents 38c has a variable depth to provide for a proportionally variable release force of the tangential force applicator 38. An outer surface 38f of the body 38a has a diameter corresponding to an inner diameter of a cross-hole 37a formed in the body 37 to provide a slide fit of the force applicator 38 inside the body 37.

The leg 35 accommodates the related elements of a locking system that cooperates with the locking detents 38c. The locking system includes a locking element 41 shaped as a ball, a locking element load applicator 42 formed as a coiled compression spring, a load transfer element 43 shaped as a ball, and a load adjustment element 44 formed as a screw. The load transfer element 43 assists in an even distribution of the load applied by the load adjustment element 44 onto the load applicator 42, and may be omitted depending upon specific application requirements. The leg 35 has a longitudinally extending through-hole 35a formed therein provided with internal threads 35b to retain the load adjustment element 44. The load adjustment element 44 retains the locking element 41, the locking element load applicator 42 and the load transfer element 43 in the through-hole 35a. The through-hole 35a opens into the cross-hole 37a to permit the locking element 41 to engage a selected one of the locking detents 38c. The leg 35 has a plurality of rows of teeth 35c formed thereon and the rows extend in the longitudinal direction of the leg for a press fit with the driver arm 31.

The tightening torque values selector knob 39 incorporates a number of torque values markings 39a, 39b with the number of markings being equal to the number of the detents 38c. The body 37a includes selector mark 37b that aligns with the markings 39a, 39b to indicate the torque value that is selected. When the tangential force limiter 32 is assembled, the body 38a is inserted into the cross-hole 37a and then into the stepped aperture 39c. The retaining screw 40 is inserted into the stepped aperture 39c and threadably engaged with the threaded hole 38e.

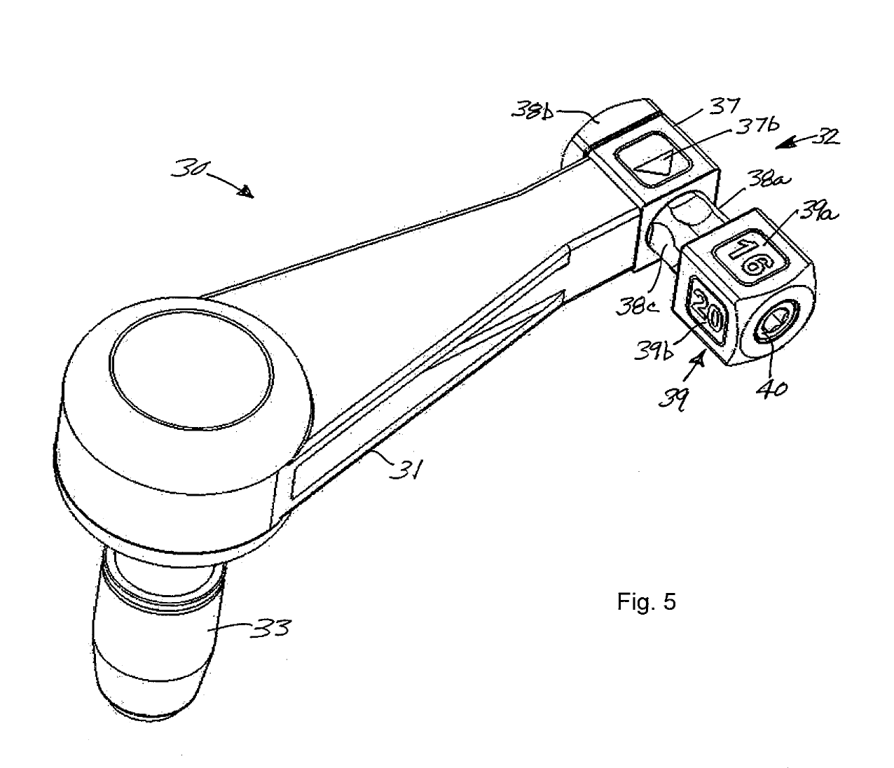

In operation, the load applicator 42, formed as preset compression spring, and the depth of the selected one of the locking detents 38c determine the force that must be applied to the force applicator button 38b to cause the tangential force applicator to slide in the cross-hole 37a. As shown in FIG. 5, the tangential force applicator 38 has been actuated to slide the body 38a in the body 37 to disengage the locking detent 38c from the locking element 41. The selector knob 39 is rotated in either direction to align a selected one of the locking detents 38c with the locking element 41.

The torque driver 30 includes the fixed length driver arm 31 for rigidly mounting the driver spindle 33 and receiving the tangential force limiter 32, made as a separate sub-assembly (module). The tangential force limiter 32 is calibrated outside the torque driver and then assembled with the driver arm 31. A press fit can be used and alternatives are retaining screw(s), adhesives, etc. The tangential force limiter 32 incorporates at least one, but typically, several ball locking detents 38c. The detents 38c have different depths to create different force applicator release forces, which is a function of the ball detent depth and the preset spring load of the load applicator spring 42 acting on the locking element ball 41. While preset spring load has a constant value, the depth of the ball sitting in the various detents is different. The deeper in the detent the ball sits, the more force is required to disengage the ball from the detent. The force to cause disengagement (or force required to unlock the force applicator from the bail and let it slide in the tangential direction) is actually equal to the limit of tangential force set up by the user. The user sets up this limit by pushing the force applicator 38 in so that the force applicator unlocks as the ball 41 is pushed out of the detent 38c and still rides in the indexing groove 38d. The indexing groove 38d has a smaller depth than the locking detent 38c, and is used to keep the force applicator 32 from losing orientation relative to the tangential force limiter body 37. The user then grabs the knob 39 and rotates it to set the tightening torque value mark 39a, 39b (desired by the user) against the “arrow” mark 37b on the body 37. The user then pushes the force applicator back so that the ball 41 engages the desired related ball detent 38c and the set up procedure is completed.

To use the torque driver 31, the user mounts appropriate means to engage the head of a fastener, for example a screwdriver bit or a socket (not shown) with the spindle 33. User then grasps the driver arm 31 with a palm of a hand, engages the fastener and uses a finger (typically, a thumb) to apply force to the button 38b of the force applicator 38 in a clockwise direction (FIG. 2) relative to the axis of rotation 31c. When the applied force, specifically, a tangential vector of applied force exceeds the limit force, previously set with use of the knob 39, the force applicator 38 will slide in the body 37 in a tangential and clockwise direction indicating that the selected tangential force, and, correspondingly, the selected tightening torque was delivered to the fastener.

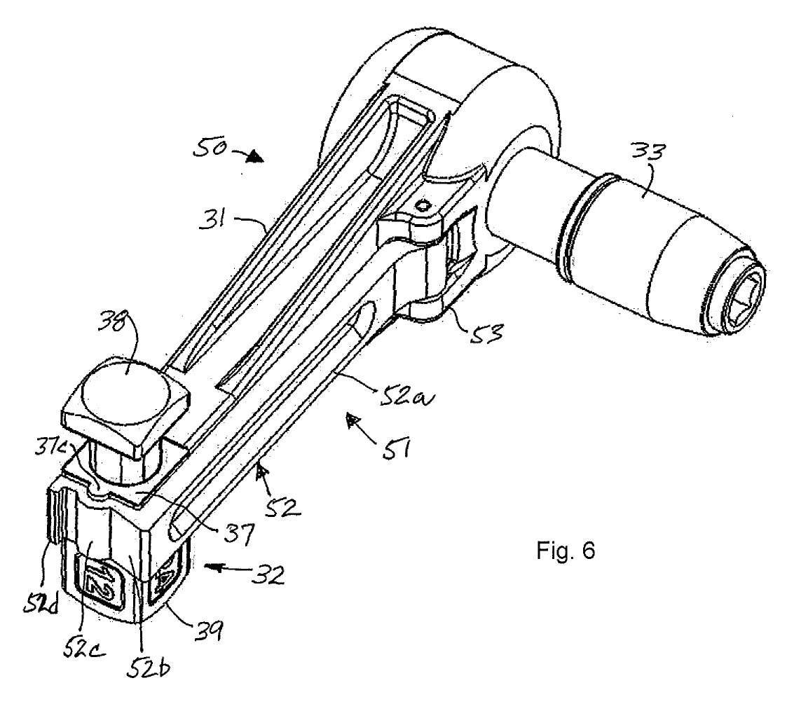

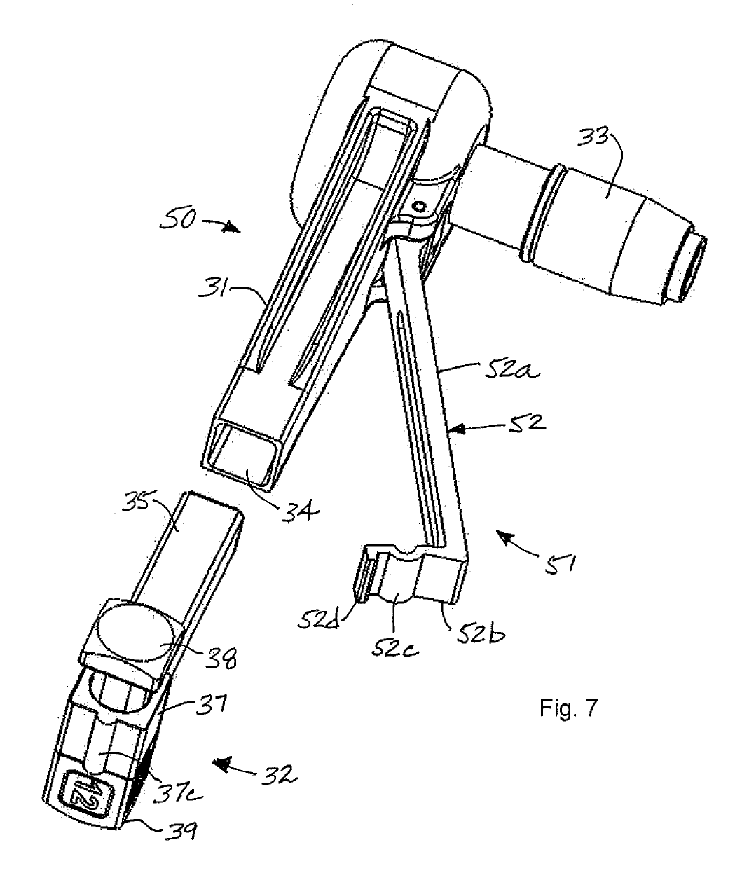

A third embodiment torque driver 50 is shown in FIGS. 6 and 7 and includes the fixed length driver arm 31 with the rigidly mounted driver spindle 33 and a replaceable tangential force limiter 32 formed as a separate sub-assembly (module). The force limiter 32 has the body 37, the force applicator 38 and the selector knob 39 of the second embodiment torque driver 20. However, instead of the press fit with the driver arm 31, the force limiter module 32 is a slide fit so that it is easily separated from the arm for quick replacement (insertion, removal, locking) of limiters by the user. The force limiter 32 is calibrated while separated from the torque driver arm 31, and then assembled with the driver arm. When the force limiter 32 is inserted into the driver arm 31, it is secured in place by the retainer 51. The retainer 51 is shown as a latch, but options include retaining screw(s), pins or any other releasable retaining means.

The retainer 51 includes an L-shaped latch lever 52 that has a longer leg 52a attached to a shorter leg 52b. A free end of the longer leg 52a is pivotally connected to the arm 31 at a clevis 53 on the driver arm 31. The body 37 has a ridge 37c facing the shorter leg 52b. The shorter leg 52b has a groove 52c that cooperates with the ridge 37c to retain the force limiter 32 in the driver arm 31. The latch lever 52 is formed to be somewhat flexible so that the shorter leg 52b can be deflected to release from and engage with the ridge 37c. A free end of the shorter leg 52b has a flange 52d formed thereon to assist in deflecting the leg. The latch lever 52 enables the user to utilize several different force limiters 32 with different settings, as a kit, and use the same driver arm 31 and spindle 33 with any of them. This makes it possible to expand the number of available torque settings. For example, if the original tangential torque limiter has four torque settings as shown in the drawings, each additional force limiter can add four more different settings.

The force limiters 32 can be provided with any number of settings. For example, the user can have a limiter with four settings, identical in design and mating surfaces, a limiter with six settings and another one with five settings. Thus, the user will have a total of fifteen torque setting with just these three limiters. As long as these limiters have identical mating surfaces and critical dimensions, any of these limiters can be used with the same driver arm. This is an example of a modular design approach. The other benefit is the ease of repair and maintenance—a limiter can be removed by the user, sent out for calibration, and reinstalled by the user.

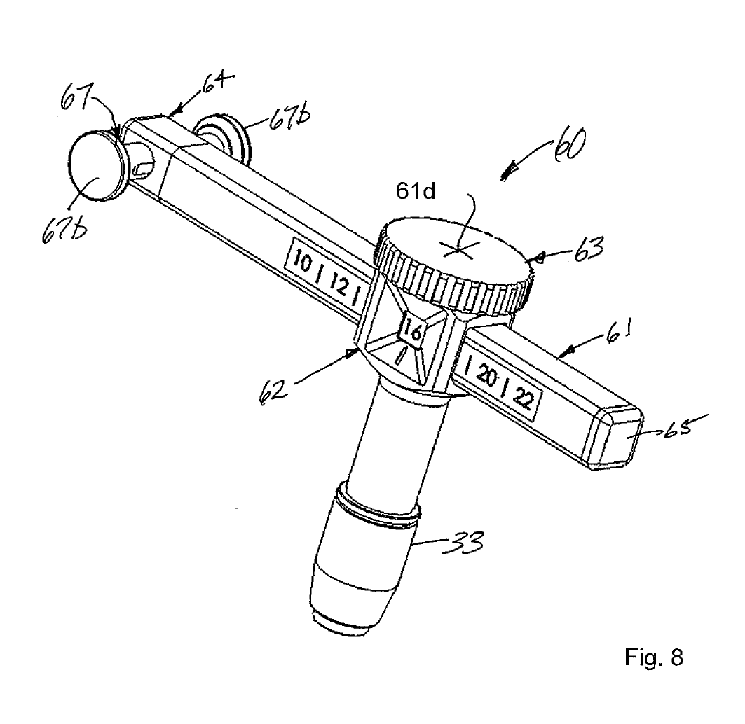

A fourth embodiment torque driver 60 is shown in FIGS. 8-12. The torque driver 60 includes a continuously adjustable length driver arm 61 slidably mounted into an upper spindle body 62 of the driver spindle 33. A clamp 63 secures driver arm 61 in the spindle body 62. A tangential force limiter 64, constructed as a separate sub-assembly (module), is permanently mounted at one end 61 b of the driver arm 61. As explained below, the tangential force limiter 64 has a double sided force applicator. However, a single sided force applicator is also an option, which can be useful if the torque driver is designed to torque fasteners in both clockwise and counterclockwise directions.

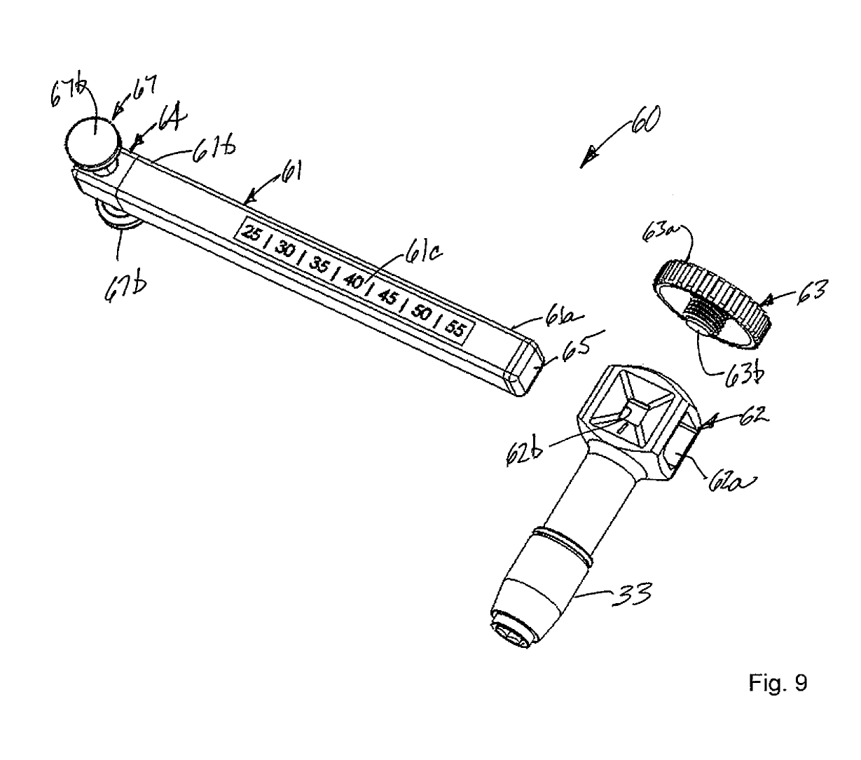

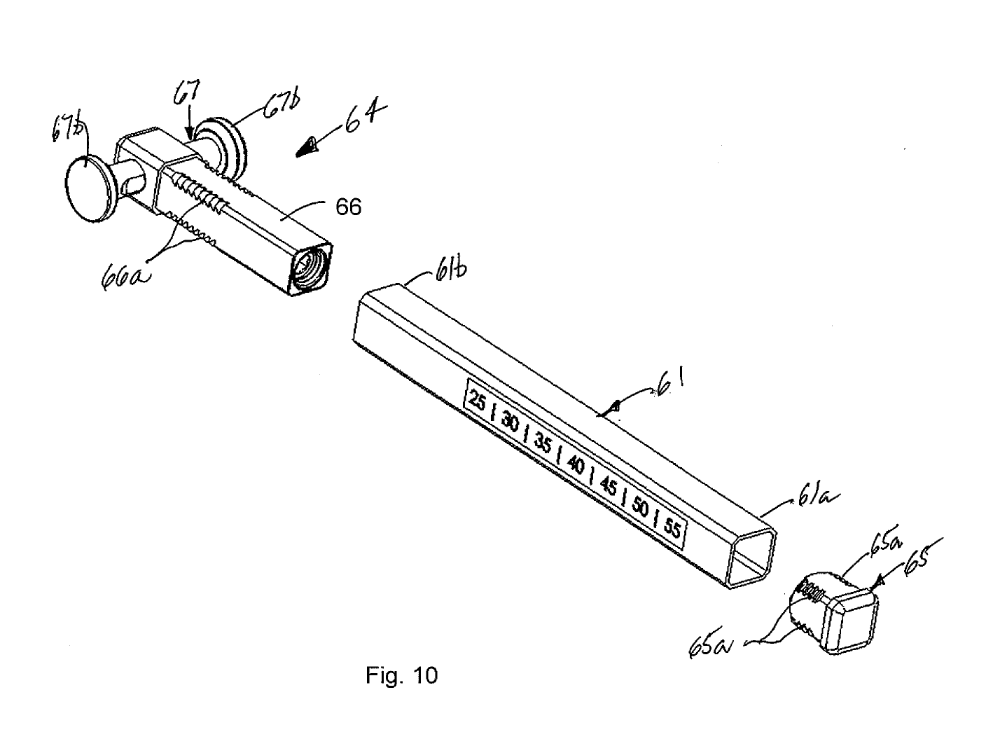

In the torque driver 60, the tangential force limiter 64 is calibrated as a separate module and then assembled with the driver arm 61, As shown in FIG. 10, the driver arm 61 can be formed with a tubular body having an open first end 61a receiving a plug 65. The plug 65 has a plurality of external teeth 65a formed thereon for securing the plug in the opening. An open second end 61 b of the driver arm 61 receives a leg 66 of the force limiter 64 with a press fit assisted by a plurality of external teeth 66a formed on the leg. Then the driver arm first end 61a is slidably inserted into a through-hole 62a formed in the upper spindle body 62. A plurality of torque value markings 61c are provided on a side wall of the driver arm 61, which markings are visible one at a time in a viewing window 62b formed in the upper spindle body 62 and being in communication with the through-hole 62a. The user slides the driver arm 61 in the through-hole 62a until the desired torque value appears in the viewing window 62b and then fixes the driver arm in place with the clamp 63. As shown in FIG. 9, the clamp 63 is in the form of a thumbscrew with a flat circular head 63a from which a threaded shank 63b extends. The shank 63b threadably engages a threaded hole (not shown) in the top of the upper spindle body 62, which hole is in communication with the through-hole 62a. Thus, the clamp 63 can be rotated to engage the free end of the shank 63b with the driver arm 61 to fix the driver arm in a selected position. Other suitable methods of clamping can be also used.

Continuous adjustment of the tightening torque is provided by the change in distance between a centerline of a button 67b of a force applicator 67 and an axis of rotation 61 d of the driver arm 61 and the spindle 33. The driver arm 61 is moved in and out of the driver upper spindle body 62 until the desired torque value from available range is shown in the window 62b of the spindle body. After positioning the driver arm 61 at the desired setting, driver arm is secured to the body 62 with the clamp 63. The clamp shank 63b has flat clamping surface at the end in order to clamp the driver arm 61 anywhere along its length.

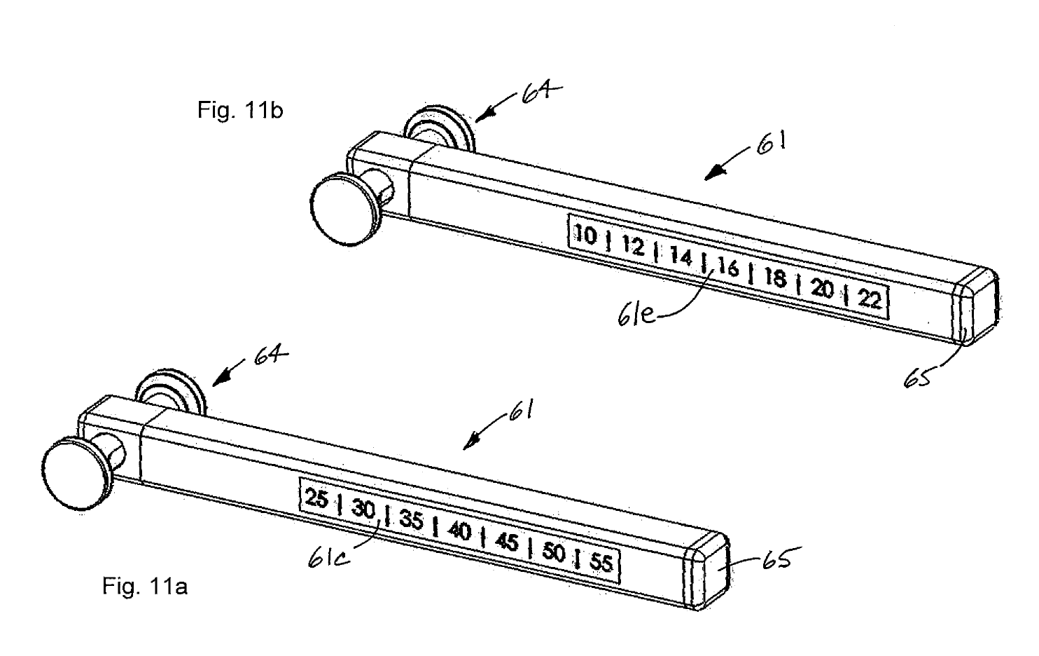

The driver arm 61 has a second plurality of torque value markings 61e on the side opposite the markings 61c, as shown in FIG. 11b, but only the one setup viewing window 62b in the upper spindle body 62. Considering that the tightening torque is applied in the clockwise direction about the axis of rotation 61d, only one set of the markings need be visible through the window during use. As explained below, the torque driver 60 has two torque settings ranges available by rotating the driver arm 61 180° prior to insertion in the through-hole 62a.

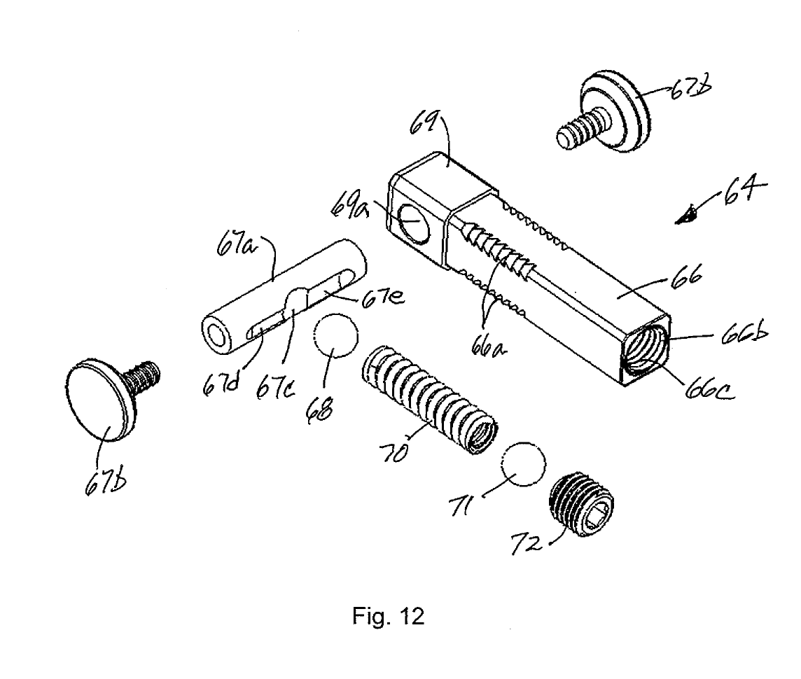

The tangential force limiter 64 has a double sided force applicator 67 that provides two different forces, on the left and on the right, to overcome resistance of a ball detent locking arrangement. This is achieved by use of single asymmetrical ball detent, which detent has two indexing grooves of different depth on the left and on the right side of the ball detent. As shown in FIG. 12, an elongated body 67a threadably retains a pair of force applicator buttons 67b at opposite ends. A locking detent 67c is formed at a midpoint of the body 67a. A shallower groove 67d extends longitudinally from the locking detent 67c toward the left button 67b and a deeper groove 67e extends longitudinally from the locking detent 67c toward the right button 67b. The deeper groove 67e generates less resistance to disengage a locking element (ball) 68 from the detent 67c than does the shallower groove 67d. As in the previous embodiments, the leg 66 is attached to a body having a cross-hole 69a formed therein for slidably receiving the force applicator body 67a. The leg 66 has a longitudinally extending through-hole 66b that communicates with the cross-hole 69a and has threads 66c at the free end. The through-hole 66b receives the locking element 68, a load applicator 70 in the form of a compression spring and a load transfer element 71 in the form of a ball, and is closed by a threaded load adjustment element 72.

When it's time to change from one torque settings range to the other, the user will release the clamp 63, pull the driver arm 61 out of the upper spindle body 62, flip driver arm 180°, and slide the driver arm back into the body so that the other set of markings will be visible in the setup window 62b. This also changes the orientation of the force applicator buttons 67b and the grooves 67d and 67e, and correspondingly, the tangential force limits will also change places from left to right or right to left. Because the user only utilizes a clockwise rotation of the torque driver 60, only one of two available forces is used for tightening of the fasteners. The other force becomes “active” only when torque driver arm 61 is flipped over to the other side.

An alternative design utilizes a symmetrical tangential force limiter, with the limit force on the left and on the right of the force applicator being equal. This is achieved by using grooves of the same depth. Such a torque driver only has a single torque setting range, but can be used to apply torque both clockwise and counterclockwise directions.

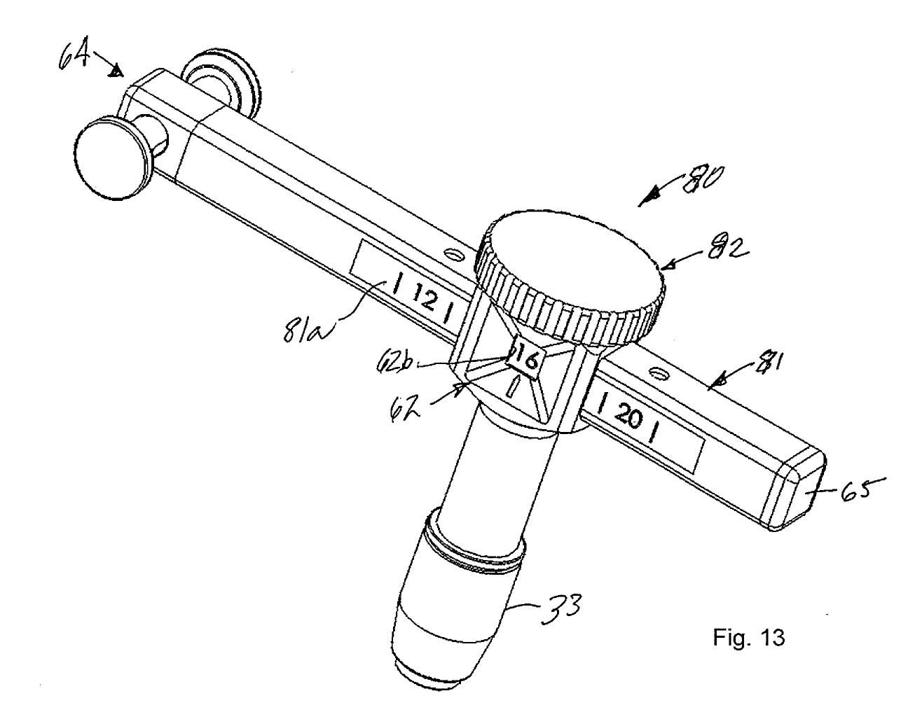

A fifth embodiment torque driver 80 is shown in FIGS. 13, 14a, 14b and 15. The torque driver 80 includes the driver spindle 33, the upper spindle body 62 and the tangential force limiter 64 from the torque driver 60. However, this embodiment utilizes a selectable step length driver arm 81 slidably mounted into the upper spindle body 62 and a cooperating clamp 82 to secure driver arm in place. Although the tangential force limiter 64 is a double sided force applicator, a one sided force applicator is an option, which can be useful if the torque driver is designed to torque in both the clockwise and the counterclockwise directions.

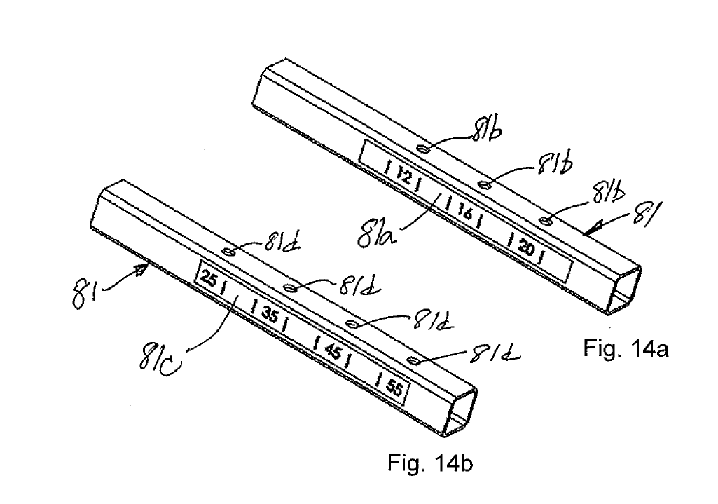

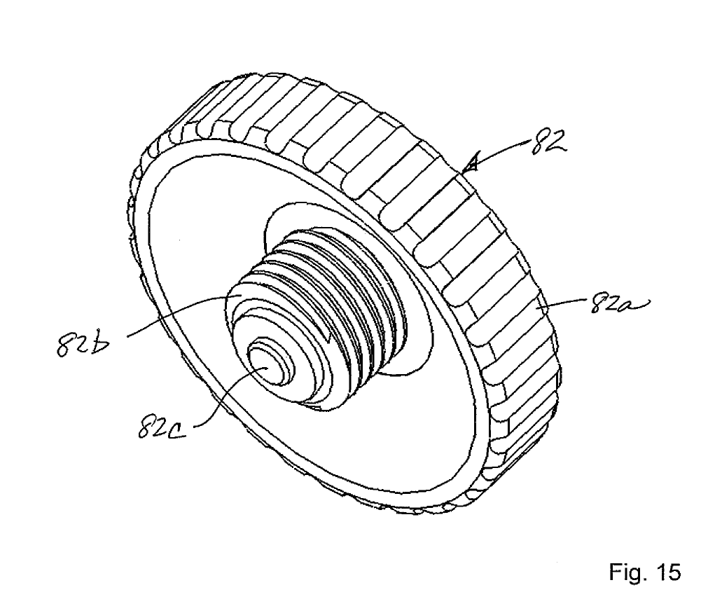

As shown in FIG. 14a, the driver arm 81 has a first set of torque value markings 81a on one side wall. On a top wall a first plurality of locating holes 81b is formed wherein each of the holes is aligned with one of numbers of the markings 81a. As shown in FIG. 14b, the driver arm 81 has a second set of torque value markings 81c on a side wall opposite the markings 81a. On a bottom wall a second plurality of locating holes 81d is formed wherein each of the holes is aligned with one of numbers of the markings 81c. The holes 81b and 81d are located at predetermined distances from the force applicator 67 of tangential force limiter 64. The clamp 82, shown in FIG. 15, has a head 82a and a threaded shank 82b similar to the clamp 63, but includes a locating pin 82 extending from the end of the shank to engage the locating holes 81b and 81d. The user simply selects one of the available several settings, slides the driver arm 81 in the upper spindle body 62 until the selected marking is seen in the window 62b, and then uses the clamp 82 to secure the driver arm in such a manner that the locating pin 82c engages the hole 81b or 81d corresponding to the desired torque setting, with the principal result being an extremely high repeatability of the selected tightening torque values independent of the ability of the user to precisely align torque value makings 81a and 81 c within the window 62b.

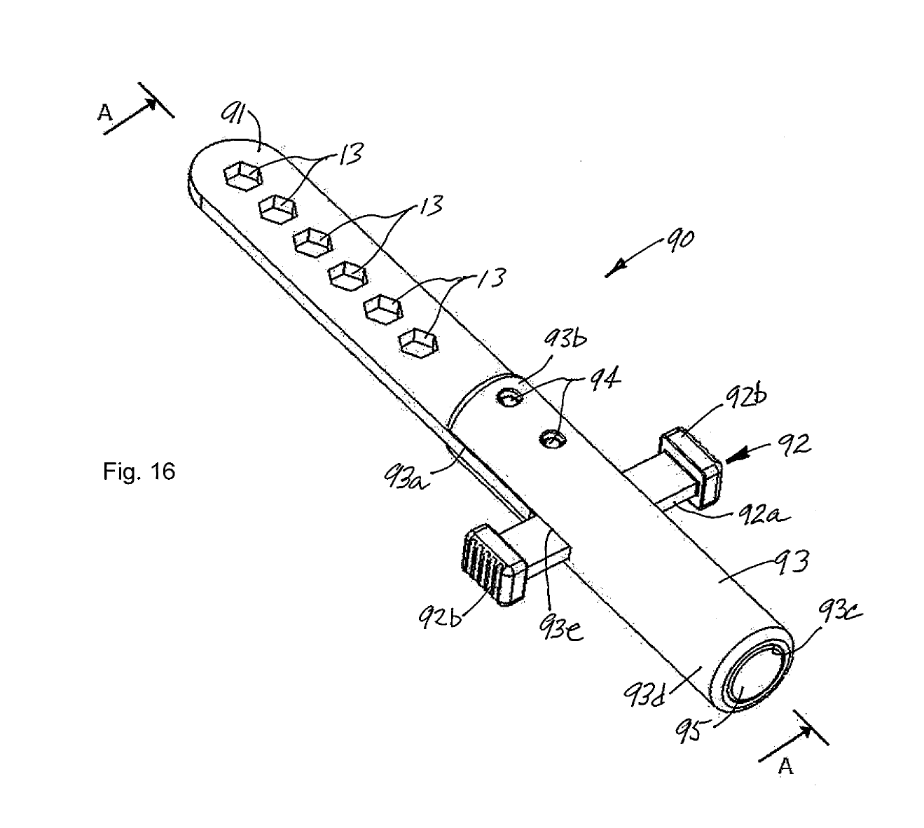

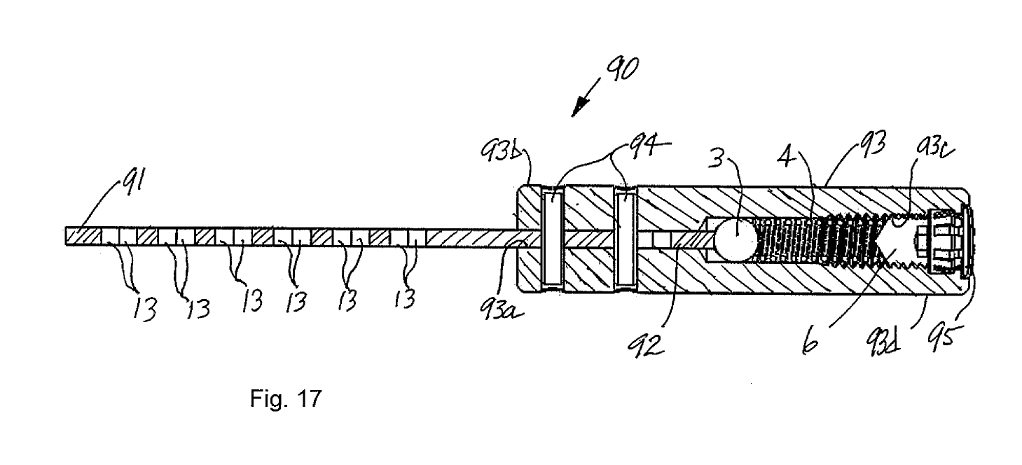

A sixth embodiment torque driver 90, shown in FIGS. 16-18, is generally similar to design of the torque driver 20 shown in FIG. 1. Parts of the torque driver 90 that correspond to parts of the torque driver 20 are identified with the same reference numerals. The torque driver 90 includes a driver arm 91 having a plurality of driver spindle sockets 13 formed as hex holes spaced at pre-determined distances from a tangential force applicator 92. The sockets 13 are sized to retain the driver spindle 11 in cooperation with the retaining knob 12. One end of the driver arm 91 extends into a slot 93a formed in a first end 93b of the handle 93 and is fixedly attached with any suitable means such as a pair of rivets 94. The handle 93 includes a longitudinally extending bore 93c that is open at a second end 93d. Retained in the bore 93c are a locking element 3 in the form of a ball, a locking element load applicator 4 in the form of a compression spring, and a load adjustment screw 6 threaded into the open end 93d. The bore 93c is closed by a cap 95. Thus, the handle 93 functions as a tangential force limiter housing.

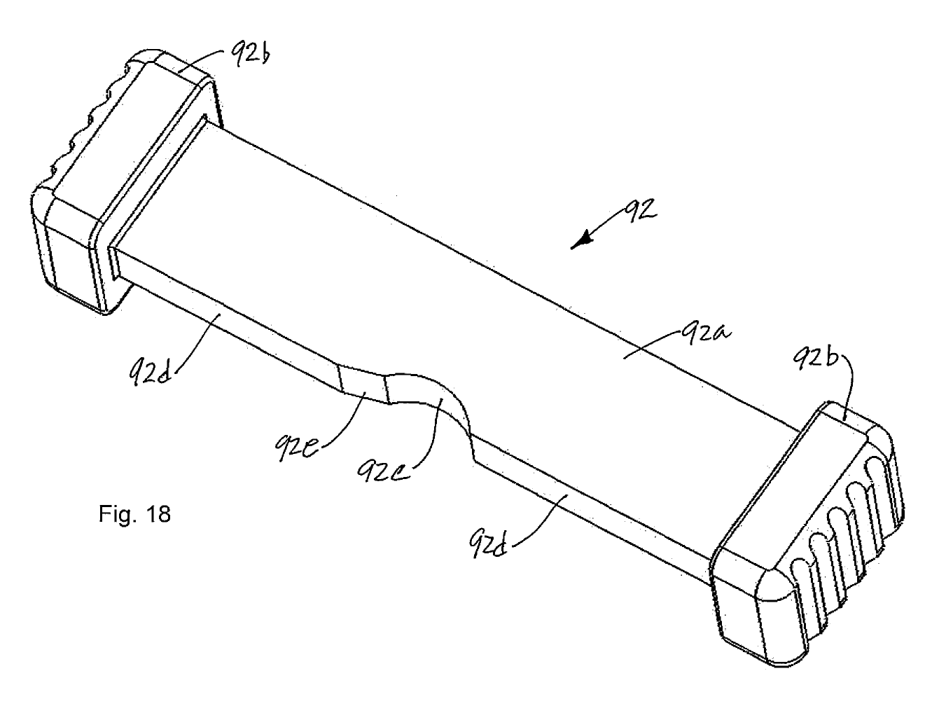

The handle 93 includes a rectangular cross-section cross-hole 93e extending transverse to and in communication with the bore 93c. The force applicator 92 is slidably mounted in the cross-hole 93e between the driver arm 91 and the ball 3. The force applicator 92 has an elongated planar body 92a with a force applicator button 92b attached at either end. A locking detent 92c is formed at a midpoint of the body 92a along an edge 92d for receiving the ball 3. The depth of the detent 92c relative to the edge 92d determines the amount of force that must be applied to one of the buttons 92b to actuate at a predetermined torque limiting value. If the portions of the edge 92d on both sides of the detent 92c are in a common plane, the torque limiting value will be the same for each of the buttons 92b. However, two different torque limiting values can be provided by shaping a portion of the edge 92d adjacent one side of the detent 92c to provide a shallower depth. As shown in FIG. 18, a ramp portion 92e extends at an angle from the plane of the edge 92d to the detent 92c to provide a shallower depth with a lower resulting torque limiting value than at the other side of the detent.

Although the tangential force limiter of the torque driver 90 has a double-sided force applicator 92, a single-sided force applicator is also an option, which can be useful if the torque driver is designed to torque both in the clockwise and the counterclockwise directions.

The various embodiments of the torque driver invention described above all include a driver spindle, a driver arm and tangential force limiter being positioned a predetermined distance from an axis of rotation of the spindle. A plurality of torque limiting values can be provided by changing the predetermined distance and/or providing the force applicator with a force limit adjustment means. The tangential force limiter can also include a tangential force applicator that can be double-sided or single-sided. For example, the force limiter 64 (FIG. 8) could be substituted for the force limiter 32 (FIG. 3) to increase the number of torque limiting values by a factor of four. In all embodiments the force applicator of tangential force limiter moves relative to the drive arm to prevent further application of the tightening force to the object upon being exposed to a pre-defined value of the tightening force.

The invention also includes a method of limited torque fastener tightening by the steps of: providing a driver spindle; connecting the driver spindle to a driver arm; providing a tangential force limiter including a tangential force applicator; connecting the force limiter to the driver arm; selecting a predetermined tightening torque by either adjusting a distance between the force applicator and an axis of rotation of the driver spindle, or by adjusting a value of an actuating force of the force limiter, or both of them at the same time; engaging the driver spindle with an object to be rotated; and applying a tightening force to the force applicator to rotate the arm and the driver spindle whereby the force applicator moves relative to the driver arm to prevent further application of the tightening force to the object upon being exposed to adjusted value of the tightening force.

This invention allows the building of torque drivers of various configurations, in which all of these factors can be either fixed and non-adjustable by the user, or they can be made continuously adjustable and/or selectable from a number of fixed (preset) values by the user. It is important to mention, that such wide selection of the ways to adjust the tightening torque also allows for the building of the torque driver highly optimized for a specific application and cost, and capable of providing the best value for the user.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A torque driver apparatus comprising:
a driver arm having a first end and an opposite second end;
a driver spindle attached at said first end of said driver arm; and
a tangential force limiter attached at said second end of said driver arm and including a tangential force applicator for applying a force to rotate said driver spindle about an axis of rotation, said force applicator being movable in a direction tangential to a path of rotation of said force limiter about the axis of rotation in response to application of a predetermined force to indicate that an associated predetermined tightening torque value has been applied to a fastener engaged by said driver spindle.

2. The torque driver according to claim 1 wherein said force limiter includes a locking element and a load applicator and said force applicator includes an elongated body having at least one locking detent formed therein, said load applicator forcing said locking element into said at least one locking detent wherein when the predetermined force is applied to an end of said elongated body, said elongated body moves to force said locking element from said at least one locking detent.

3. The torque driver according to claim 2 wherein said elongated body has another locking detent formed therein with a different depth than said at least one locking detent and said elongated body is rotatable about a longitudinal axis to selectively align said at least one locking detent and said another locking detent with said locking element.

4. The torque driver according to claim 3 wherein said force limiter has a body with a cross-hole slidably and rotatably retaining said elongated body.

5. The torque driver according to claim 4 wherein said force limiter has a selector knob attached to said elongated body for rotating said elongated body.

6. The torque driver according to claim 5 wherein said selector knob has a torque value marking for each said at least one locking detent and said another locking detent.

7. The torque driver according to claim 2 wherein said at least one locking detent has one of a symmetrical curved shape and an asymmetrical curved shape.

8. The torque driver according to claim 2 wherein said elongated body includes a groove formed therein and said groove extends along a longitudinal axis of said elongated body and is in communication with said at least one locking detent for receiving said locking element during movement of said elongated body in the longitudinal direction.

9. The torque driver according to claim 1 wherein said driver arm has a plurality of sockets formed therein spaced along a longitudinal axis, each said socket releasably retaining said driver spindle to provide a different distance between the axis of rotation and said force applicator.

10. The torque driver according to claim 1 wherein said driver spindle has an upper spindle body with a through-hole slidably retaining said driver arm and including a clamp mounted on said upper spindle body for engaging said driver arm to fix a distance between the axis of rotation and said force applicator.

11. The torque driver according to claim 10 wherein said driver arm has a plurality of locating holes formed therein and said clamp includes a locating pin for engaging said locating holes.

12. The torque driver according to claim 10 wherein said driver arm has at least one set of torque value markings thereon and said upper spindle body has a viewing widow for displaying an aligned one of said markings.

13. The torque driver according to claim 12 wherein said driver arm has a first one of said sets of said torque value markings on a first wall and a second one of said sets of said markings on a second wall opposite said first wall.

14. The torque driver according to claim 1 wherein said force limiter is releasably coupled to said driver arm and including a retainer pivotally mounted on said driver arm to retain said force limiter coupled to said driver arm.

15. A torque driver comprising:
a driver arm having a first end and a second end;
a driver spindle attached to said first end of said driver arm and having an axis of rotation;
a tangential force limiter attached at said second end of said driver arm and having a tangential force applicator for applying a force to rotate said driver arm and said driver spindle about the axis of rotation to apply a torque to an object engaged by said spindle driver, a locking element and a load applicator; and
wherein said force applicator has an elongated body with a locking detent formed therein, said force applicator presses said locking element into engagement with said locking detent, and said elongated body is movable in a direction tangential to a path of rotation of the force limiter about the axis of rotation in response to application of a predetermined force to indicate that an associated predetermined tightening torque value has been applied to the object.

16. The torque driver according to claim 15 wherein said locking element is a ball and said load applicator is a compression spring.

17. The torque driver according to claim 15 wherein said force applicator is rotatable between two positions for changing an amount of the predetermined force.

18. The torque driver according to claim 15 wherein said driver arm and said driver spindle are relatively movable to change a distance between the axis of rotation and the force applicator.

19. The torque driver according to claim 15 wherein said locking detent has one of a symmetrical curved shape and an asymmetrical curved shape.

20. A method of limited torque fastener tightening comprising the steps of:
providing a driver spindle;
connecting the driver spindle to a driver arm;
providing a tangential force limiter including a tangential force applicator;
connecting the force limiter to the driver arm;
selecting a predetermined tightening torque by at least one of adjusting a distance between the force applicator and an axis of rotation of the driver spindle and adjusting a value of an actuating force of the force limiter;
engaging the driver spindle with an object to be rotated; and
applying a tightening force to the force applicator to rotate the arm and the driver spindle whereby the force applicator moves relative to the driver arm to prevent further application of the tightening force to the object upon being exposed to adjusted value of the tightening force.
